(19) United States
(12) Patent Application Publication
(10) Pub. No.: US 2008/0068319 A1
(43) Pub. Date: Mar. 20, 2008

(54) Method for Driving Liquid Crystal Display

(75) Inventors: Yu-Hui Chou, Hsin-Chu (TW); Hsueh-Ying Huang, Hsin-Chu (TW); Ming-Sheng Lai, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/683,111

(22) Filed: Mar. 7, 2007

(30) Foreign Application Priority Data
Sep. 15, 2006 (TW) 95134339

(51) Int. Cl. G09G 3/36

(52) U.S. Cl. 345/89

(57) ABSTRACT

A method for driving a liquid crystal display is disclosed. A driving voltage corresponding to a gray scale is provided during a first interval of a time period to drive a pixel in response to the gray scale, and a reset voltage responsive to the gray scale is provided during a second interval of the time period.

### RELATED APPLICATIONS

This application claims priority to Taiwan Application Serial Number 95134339, filed Sep. 15, 2006, which is herein incorporated by reference.

### BACKGROUND

1. Field of Invention

The present invention relates to a method for driving a liquid crystal display. More particularly, the present invention relates to a driving method for improving the response time of pixels of a liquid crystal display.

2. Description of Related Art

Liquid crystal display (LCD) devices have recently been applied broadly in various electronic products. Because liquid crystal molecules do not generate light by themselves, a back light module is required to provide light for the liquid crystal display and for full-color display with the mixture of the three primary colors provided from the red (R), green (G), and blue (B) backlights. Typically, there are two types of backlight modules in a liquid crystal display. One is always-lighting type backlight module, and the other is a flash type backlight module. The flash type backlight module, for example, is applied to a liquid crystal display driven by a color sequential method.

In the liquid crystal display driven by the color sequential method, a driving voltage is typically provided to drive pixels, and the red, green, and blue backlights are sequentially provided to illuminate the pixels to display different color images using a residual effect. However, due to the response speed of the liquid crystal molecules, the image of the first half of the panel has been displayed because the liquid crystal molecules of the first half of the panel has already been set, while the image of the second half of the panel cannot be displayed correctly because the liquid crystal molecules of the second half of the panel has not been set yet, so that the brightness of the full image is not uniform.

The conventional method is to apply a reset voltage between two adjacent subframes to reduce the response time of the liquid crystal molecules. Consequently, the response time between two adjacent subframes can be reduced to solve the brightness problem. For this method, the reset voltage is different from and not related to the driving voltage for driving the pixels, and due to the reset voltage different from and not related to the driving voltage, however, the response time between two adjacent subframes cannot be different and comparatively shorter corresponding to different images. Therefore, the problem of brightness could still exist when a large liquid crystal display is developed, that is, the problem of brightness cannot be solved completely to optimize the image quality of the liquid crystal display.

For the foregoing reasons, there is a need to provide a driving method for improving the response time of the pixels of the liquid crystal display and optimizing the displayed images.

### SUMMARY

According to one embodiment of the present invention, a method for driving a liquid crystal display is provided. A driving voltage corresponding to a gray scale is provided during a first interval of a time period to drive a pixel in response to the gray scale. A reset voltage responsive to the gray scale is provided during a second interval of the time period.

According to another embodiment of the present invention, a method for driving a liquid crystal display is provided. A driving voltage corresponding to a gray scale is provided during a first interval of a time period to drive a pixel in response to the gray scale, and a backlight is provided to illuminate the pixel in the first interval. A reset voltage responsive to the backlight is also provided during a second interval of the time period.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIG. 1 is a diagram showing time versus changes of voltages applied to pixels according to one embodiment of the present invention; and

FIG. 2 is a table of the relationship between the reset voltages and the gray scales according to one embodiment of the present invention; and

FIG. 3 is a diagram showing time versus changes of voltages applied to pixels according to another embodiment of the present invention; and

FIG. 4 is a table of the relationship between the reset voltages and the colors of the backlights in the subframes according to one embodiment of the present invention.

### DESCRIPTION OF THE PREFERRED EMBODIMENTS

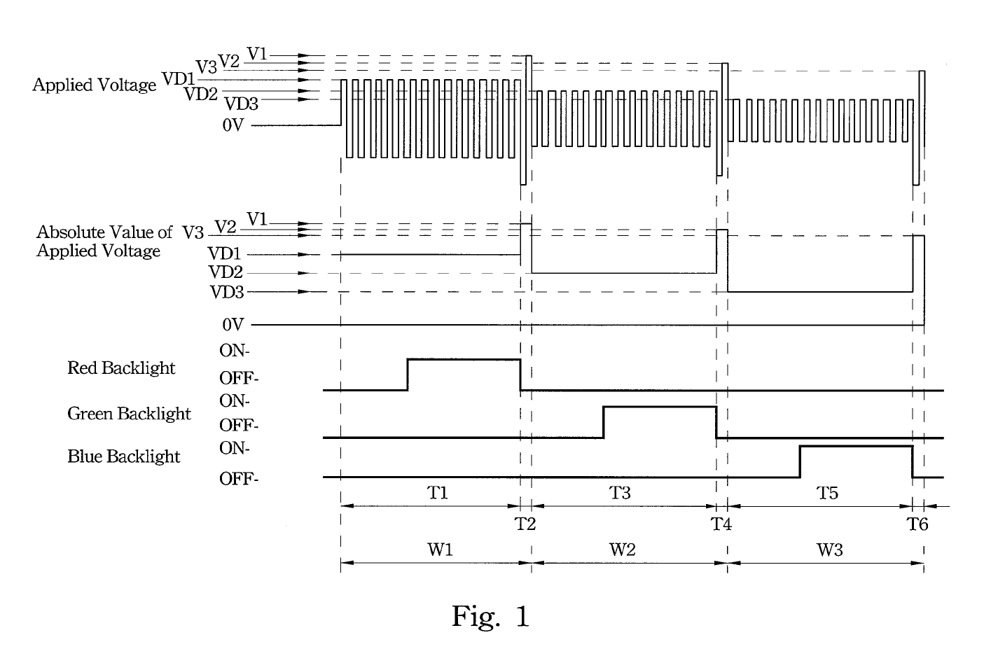

The present invention provides a method for driving a liquid crystal display to solve image brightness problems. FIG. 1 is a diagram showing time versus changes of voltages applied to pixels according to one embodiment of the present invention. Referring to FIG. 1, waveforms and absolute values of applied voltages and ON-OFF timing of red, green, and blue backlights are shown. According to one embodiment of the present invention, during the operation in a time period W1, a driving voltage VD1 is provided during a first interval T1 of the time period W1, and the driving voltage VD1 corresponds to a gray scale and drives pixels in response to different gray scales. Besides, a reset voltage V1 is provided during a second interval T2 of the time period W1 to reduce the response time of the liquid crystal molecules, so that the liquid crystal molecules can be set rapidly for the liquid crystal display to display images correctly. The reset voltage V1 is responsive to the gray scale corresponding to the driving voltage VD1 applied during the first interval T1, and the reset voltages in two adjacent time periods are different due to the different gray-scale images.

Further, in the liquid crystal display driven by the color sequential method, a frame time is usually divided into a plurality of subframe times to display a gray-scale image with the mixture of the sequential subframes. The time period W1 mentioned above is just one of a plurality of subframe times.

According to the method, a backlight has to be provided in each subframe time to display the gray-scale image on the display panel in each subframe time. Therefore, a backlight is turned on to illuminate the pixels in a duration of the first interval T1 and turned off at the end of the first interval T1, so that the gray-scale image represented by the gray scale can be displayed in the subframe time for each pixel, wherein the backlight can be red, green, or blue backlight.

In addition, the reset voltage V1 provided in the second interval T2 of the time period W1 has to reset the liquid crystal molecules in time; that is, to speed up the rotation of the liquid crystal molecules to reduce the problem of brightness uniformity due to the slow response time of the liquid crystal molecules, and to display the gray-scale image correctly on the display panel. For this reason, an absolute value of the reset voltage V1 provided in the second interval T2 has to be larger than or equal to an absolute value of the driving voltage VD1, so that the liquid crystal molecules can rotate rapidly and the response time of the liquid crystal molecules can be reduced.

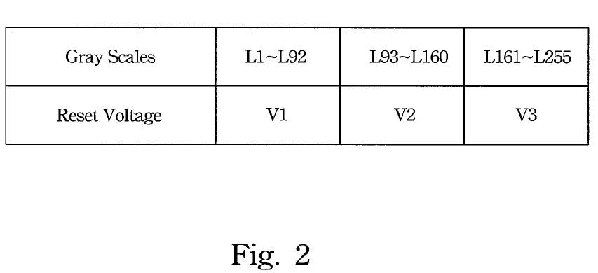

According to one embodiment of the present invention, gray scales corresponding to different driving voltages are divided into groups, so that the applied reset voltages can have different absolute values according to the different groups of gray scales corresponding to the different driving voltages. FIG. 2 is a table of the relationship between the reset voltages and the gray scales according to one embodiment of the present invention. Using the values in the table as an example, the gray scales from the black frame to the white frame are divided into a first group of gray scales, a second group of gray scales, and a third group of gray scales in the table. The first group of gray scales includes gray scale 1 to 92, and the second group of gray scales includes gray scale 93 to 160, and the third group of gray scales includes gray scale 161 to 255. Three groups of gray scales corresponds to different reset voltages, respectively, wherein the first group of gray scales corresponds to the reset voltage V1, and the second group of gray scales corresponds to the reset voltage V2, and the third group of gray scales corresponds to the reset voltage V3.

In other words, when the gray scale of the displayed gray-scale image is one of the first group of gray scales, the reset voltage V1 is provided to obtain the shortest response time of the liquid crystal molecules; and when the gray scale of the displayed gray-scale image is one of the second group of gray scales, the reset voltage V2 is provided to obtain the shortest response time of the liquid crystal molecules; and when the gray scale of the displayed gray-scale image is one of the third group of gray scales, the reset voltage V3 is provided to obtain the shortest response time of the liquid crystal molecules. Accordingly, the different reset voltages can be applied according to the IS different gray scales belonging to the different groups of gray scales to reduce the response time.

Referring to FIG. 1 and FIG. 2, when the gray scale corresponding to the driving voltage VD1 provided in the first interval T1 of the time period W1 is in the gray scale range between 1 and 92, the reset voltage provided in the second interval T2 of the time period W1 is V1; and when the gray scale corresponding to the driving voltage VD2 provided in the first interval T3 of the time period W2 is in the gray scale range between 93 and 160, the reset voltage provided in the second interval T4 of the time period W2 is V2; and when the gray scale corresponding to the driving voltage VD3 provided in the first interval T5 of the time period W3 is in the gray scale range between 161 and 255, the reset voltage provided in the second interval T6 of the time period W3 is V3. The absolute values of the reset voltages V1, V2, and V3 are respectively larger than or equal to the absolute values of the driving voltages VD1, VD2, and VD3. Further, the red, green, and blue backlights are provided to illuminate the pixels sequentially in the time periods W1, W2, and W3 to display the gray-scale images on the display panel. The method mentioned above should not be limited to the liquid crystal display driven by the color sequential method. Therefore, the spirit and scope of the appended claims should not be limited to the description of the embodiment container herein.

Furthermore, the reset voltage can have different absolute values according to gray scales corresponding to different driving voltages. In other words, when each different gray-scale image with the different gray scale is displayed in each subframe, a different reset voltage corresponding to a different gray scale is provided. Each reset voltage is provided to obtain the shortest response time between two adjacent subframes, so that the response time of the liquid crystal molecules can be reduced effectively to make the displayed images uniform.

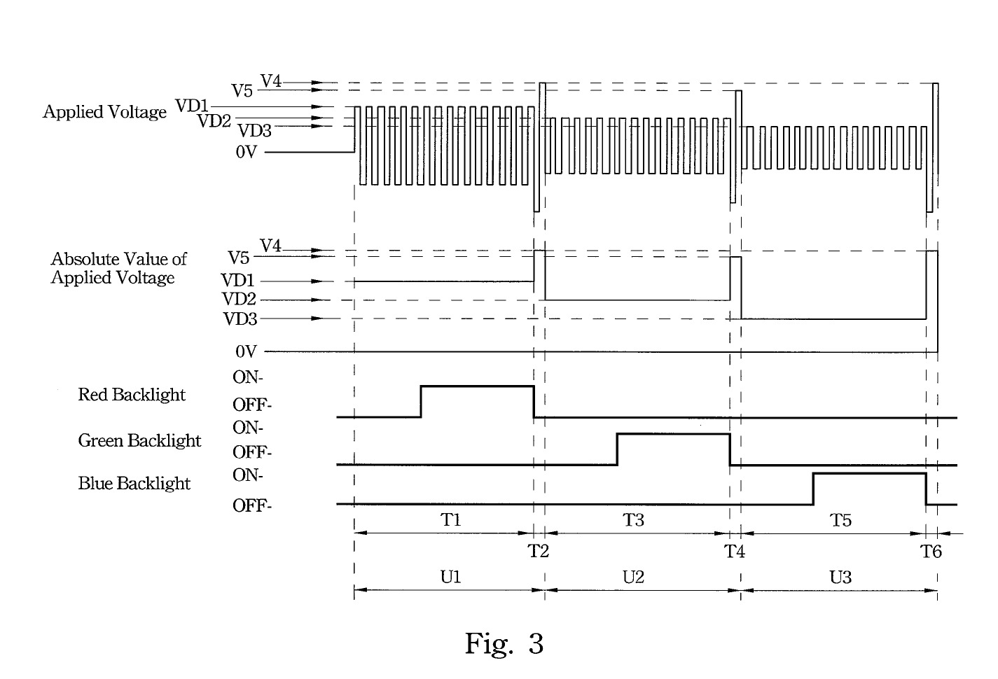

FIG. 3 is a diagram showing time versus changes of voltages applied to pixels according to another embodiment of the present invention. Referring to FIG. 3, waveforms and absolute values of applied voltages and ON-OFF timing of red, green, and blue backlights are shown as well. According to another embodiment of the present invention and taking for example the operation in a time period U1, the method includes providing a driving voltage VD1 during a first interval T1 of the time period U1. The driving voltage VD1 corresponds to a gray scale and drives pixels in response to different gray scales, and a backlight is provided to illuminate the pixels in the first interval T1. Besides, a reset voltage V4 is provided during a second interval T2 of the time period U1 to speed up the response time of the liquid crystal molecules to let the liquid crystal molecules be reset rapidly to display the gray-scale images correctly. The reset voltage V4 is responsive to the backlight provided in the first interval T1 of the time period U1, and the colors of the backlights provided in two adjacent time periods are different.

In addition, the time period U1 mentioned above is also one of a plurality of subframe times of a frame time, and the backlights provided in the subframe times are red, green, and blue backlights sequentially. Further, because the reset voltage V4 provided in the second interval T2 of the time period U1 also has to reset the liquid crystal molecules in time; that is, to speed up the rotation of the liquid crystal molecules to reduce the problem of brightness due to the slow response time of the liquid crystal molecules, and to display the gray-scale image correctly on the display panel. For this reason, the absolute value of the reset voltage V4 provided in the second interval T2 has to be larger than or equal to the absolute value of the driving voltage VD1, so that the liquid crystal molecules can rotate rapidly and the response time of the liquid crystal molecules can be reduced.

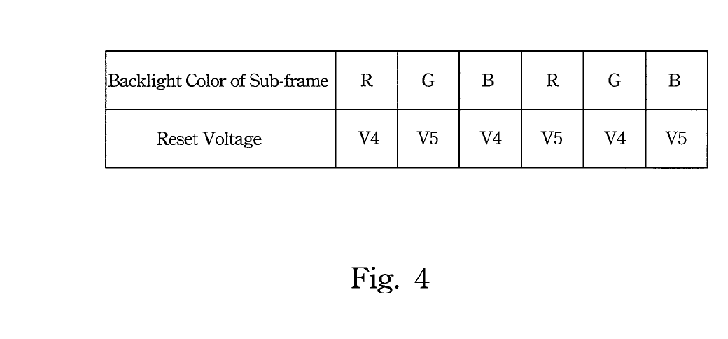

FIG. 4 is a table of the relationship between the reset voltages and the colors of the backlights in the subframes according to one embodiment of the present invention. Using the values in the table as an example, when the backlight is red, the corresponding reset voltage is V4; and when the backlight is green, the corresponding reset voltage is V5; and when the backlight is blue, the corresponding reset voltage is V4 again; and when the backlight is red again, the corresponding reset voltage is V5 again. In other words, the reset voltage is V4 in one of the two adjacent subframes, and the reset voltage is V5 different from V4 in the other one of the two adjacent subframes. Accordingly, each subframe corresponds to a reset voltage and the reset voltage is different from the reset voltage in the former subframe to reduce the response time of the liquid crystal molecules to make the displayed images uniform when using the color sequential method. Besides, each color of the backlights can correspond to a predetermined reset voltage or several predetermined reset voltages to obtain the shortest response time between two subframes.

Referring to FIG. 3 and FIG. 4, when the red backlight is provided to illuminate the pixels in the first interval T1 of the time period U1, the reset voltage provided in the second interval T2 of the time period U1 is V4. When the green backlight is provided to illuminate the pixels in the first interval T3 of the time period U2, the reset voltage provided in the second interval T4 of the time period U2 is V5. When the blue backlight is provided to illuminate the pixels in the first interval T5 of the time period U3, the reset voltage provided in the second interval T6 of the time period U3 is V4. The absolute values of the reset voltages V4 and V5 are larger than or equal to the driving voltage VD1, VD2, and VD3 provided in the time period U1, U2, and U3.

For the foregoing embodiments of the present invention, a corresponding reset voltage is provided, when a different gray-scale image is displayed, to rotate the liquid crystal molecules more rapidly to reduce the response time of the liquid crystal molecules and to obtain a uniform image.

As is understood by a person skilled in the art, the foregoing descriptions of the embodiments of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While an embodiment of the invention has been illustrated and described, it will be appreciated that various changes can be made therein without departing from the spirit and scope of the invention.

What is claimed is:

1. A method for driving a liquid crystal display, comprising:
providing a driving voltage corresponding to a gray scale during a first interval of a time period to drive a pixel in response to the gray scale; and
providing a reset voltage responsive to the gray scale during a second interval of the time period.

2. The method of claim 1, wherein the time period is one of a plurality of subframe times of a frame time.

3. The method of claim 1, further comprising turning on a backlight in the first interval.

4. The method of claim 3, wherein the backlight comprises a red, green, or blue backlight.

5. The method of claim 1, wherein the absolute value of the reset voltage is larger than or equal to the absolute value of the driving voltage.

6. The method of claim 1, wherein different gray scales corresponding to different driving voltages are divided into a first group of gray scales and a second group of gray scales, and when the gray scale in the first interval is one of the first group of gray scales, the reset voltage is a first voltage; and when the gray scale in the first interval is one of the second group of gray scales, the reset voltage is a second voltage different from the first voltage.

7. The method of claim 1, wherein the reset voltage has different absolute values corresponding to different groups of gray scales.

8. A method for driving a liquid crystal display, comprising:
providing a driving voltage to a pixel to display an image during a first interval of each time period; and
providing a reset voltage to the pixel during a second interval of each time period, wherein the reset voltages in two adjacent time periods are different.

9. The method of claim 8, wherein a backlight is provided to illuminate the pixel in the first interval.

10. The method of claim 9, wherein the backlight is a red, green, or blue backlight.

11. The method of claim 8, wherein an absolute value of the reset voltage is larger than or equal to an absolute value of the driving voltage in one time period.

12. The method of claim 8, wherein gray scales corresponding to different driving voltages are divided into a first group of gray scales and a second group of gray scales, and when the gray scale in the first interval is one of the first group of gray scales, the reset voltage is a first voltage; and when the gray scale in the first interval is one of the second group of gray scales, the reset voltage is a second voltage, which is different from the first voltage.

13. The method of claim 8, wherein the reset voltage has different absolute values corresponding to different groups of gray scales.

14. A method for driving a liquid crystal display, comprising:
providing a driving voltage corresponding to a gray scale during a first interval of a time period to drive a pixel in response to the gray scale, and providing a backlight to illuminate the pixel in the first interval; and
providing a reset voltage responsive to the backlight during a second interval of the time period.

15. The method of claim 14, wherein the time period is one of a plurality of subframe times of a frame time.

16. The method of claim 15, wherein colors of the backlights in two adjacent subframe times are different.

17. The method of claim 15, wherein the backlight provided in the subframe times is a red, green, and blue backlight sequentially.

18. The method of claim 15, wherein the reset voltage in one of two adjacent subframe times is a first voltage, and the reset voltage in the other one of two adjacent subframe times is a second voltage different from the first voltage.
